(19) United States
(12) Patent Application Publication
(10) Pub. No.: US 2021/0112710 A1
(43) Pub. Date: Apr. 22, 2021

(54) Electric Power Hover Lawn Mower

(71) Applicant: Bluebird Turf Products LLLP, A Delaware Limited Liability Partnership, Auburn Hills, MI (US)

(72) Inventors: Anthony Joseph Carmen, Bloomfield Hills, MI (US); Nicholas Anthony Salvatore, Shelby Township, MI (US)

(21) Appl. No.: 17/073,753

(22) Filed: Oct. 19, 2020

Related U.S. Application Data
(60) Provisional application No. 62/923,255, filed on Oct. 18, 2019.

(51) Int. Cl. A01D 34/695; A01D 34/00; A01D 34/82; A01D 34/68; A01D 34/78

(52) U.S. Cl. CPC A01D 34/695; A01D 34/006; A01D 2101/00; A01D 34/68; A01D 34/78; A01D 34/824

(57) ABSTRACT

An electric power hover lawn mower is employed in use to care for lawns. The electric power hover lawn mower is battery-powered and includes a deck housing, a handle, a main housing, an electric motor, an impeller, and a blade, among other possible components. The deck housing has an underside. The handle extends from the deck housing. The main housing is supported on the deck housing, and has one or more battery cavities. A battery, such as a lithium-ion battery, is received in the battery cavity(s) and powers the electric motor. The electric motor is housed by the main housing, and has a shaft that drives rotational motion of the impeller and of the blade. The impeller resides at the deck housing's underside, and the blade also resides at the deck housing's underside.

### CROSS-REFERENCE TO RELATED APPLICATION

This application claims the benefit of U.S. Provisional Patent Application No. 62/923,255, filed Oct. 18, 2019.

### INTRODUCTION

The present disclosure generally relates to lawn care equipment and, more particularly, relates to hover lawn mowers used to cut grass in lawns of yards, gardens, parks, and other areas.

Hover lawn mowers are rotary mowers that float on a cushion of air produced between the hover lawn mowers and the underlying ground. The cushion of air raises the hover lawn movers and elevates them above the ground. Since they lack wheels like wheeled rotary mowers, hover lawn mowers can be maneuvered more easily by an operator and moved side-to-side in addition to forward and backward when employed in use to cut grass. Past hover lawn mowers are commonly powered by gasoline engines.

### SUMMARY

In an embodiment, an electric power hover lawn mower is employed for use in cutting grass on lawns. The electric power hover lawn mower may include a deck housing, a handle, a main housing, an electric motor, an impeller, and a blade. The deck housing has an underside. The handle extends from the deck housing. The main housing is supported on the deck housing and has one or more battery cavities for reception of one or more batteries. The electric motor can be powered by the battery(s). The electric motor is housed by the main housing and has a shaft. The impeller is driven to rotate by the electric motor's shaft when the electric motor is activated. The impeller resides at the underside of the deck housing. The blade is driven to rotate by the electric motor's shaft when the electric motor is activated. The blade resides at the underside of the deck housing.

In an embodiment, an electric power hover lawn mower may include a deck housing, a handle, a main housing, an electric motor, an impeller, and a blade. The handle extends from the deck housing. The main housing is supported on the deck housing. The main housing has multiple first walls that establish a first interior region of the main housing, and has multiple second walls that establish a second interior region of the main housing. The main housing further has one or more battery cavities that reside at the first interior region. The electric motor resides at the second interior region of the main housing, and has a shaft. The impeller is driven to rotate by the electric motor's shaft when the electric motor is activated. Likewise, the blade is driven to rotate by the electric motor's shaft when the electric motor is activated.

In an embodiment, an electric power hover lawn mower may include a deck housing, a handle, a bail control arm, a lever, a main housing, one or more batteries, an electronic control unit, an electric motor, an impeller, and a blade. The deck housing has an underside. The handle extends from the deck housing. The bail control arm is located at the handle, and the lever is located adjacent the bail control arm. The main housing is supported on the deck housing. The main housing has one or more battery cavities. The battery(s) are received in the battery cavity(s). The electronic control unit is housed by the main housing. The electric motor can be powered by the battery(s). The electric motor is housed by the main housing and has a shaft. The impeller is driven to rotate by the electric motor's shaft when the electric motor is activated. The impeller resides at the underside of the deck housing. The blade is driven to rotate by the electric motor's shaft when the electric motor is activated. The blade resides at the underside of the deck housing. In order to activate the electric motor and hence cause rotation of the impeller and of the blade, the lever is moved to an open position and the bail control arm is moved to a pulled position.

### BRIEF DESCRIPTION OF THE DRAWINGS

One or more aspects of the disclosure will hereinafter be described in conjunction with the appended drawings, wherein like designations denote like elements, and wherein:

FIG. 1 is a perspective view of an embodiment of an electric power hover lawn mower;

FIG. 2 is a partly exploded view of the electric power hover lawn mower;

FIG. 3 is a bottom view of the electric power hover lawn mower;

FIG. 4 is a sectional view of the electric power hover lawn mower taken at arrowed lines 4-4 in FIG. 1; and

FIG. 5 is a sectional view of the electric power hover lawn mower taken at arrowed lines 5-5 in FIG. 1.

### DETAILED DESCRIPTION

Referring to the drawings, an embodiment of an electric power hover lawn mower 10 is presented in the figures and detailed in this description. The electric power hover lawn mower 10 is of the walk-behind type, and is employed in use to cut grass growing in lawns for yards, gardens, parks, and other areas including private and public areas, as well as residential and commercial areas. Compared to past gasoline-powered power hover lawn mowers with gasoline engines, the electric power hover lawn mower 10 is battery-powered and has a significant reduction in noise, vibration, and harshness (NVH). Diminished vibration at the electric power hover lawn mower's handle means that an operator can physically operate the electric power hover lawn mower 10 for a longer period of time. And diminished noise emitted by the electric power hover lawn mower 10 means that it can be operated at times that would otherwise be prohibitive by local ordinances or off-limits in other respects such as during early morning hours. Furthermore, since it is battery-powered, the electric power hover lawn mower 10 is cordless. The electric power hover lawn mower 10 is also lighter in weight and better for the environment than the gasoline-powered power hover lawn mowers of the past.

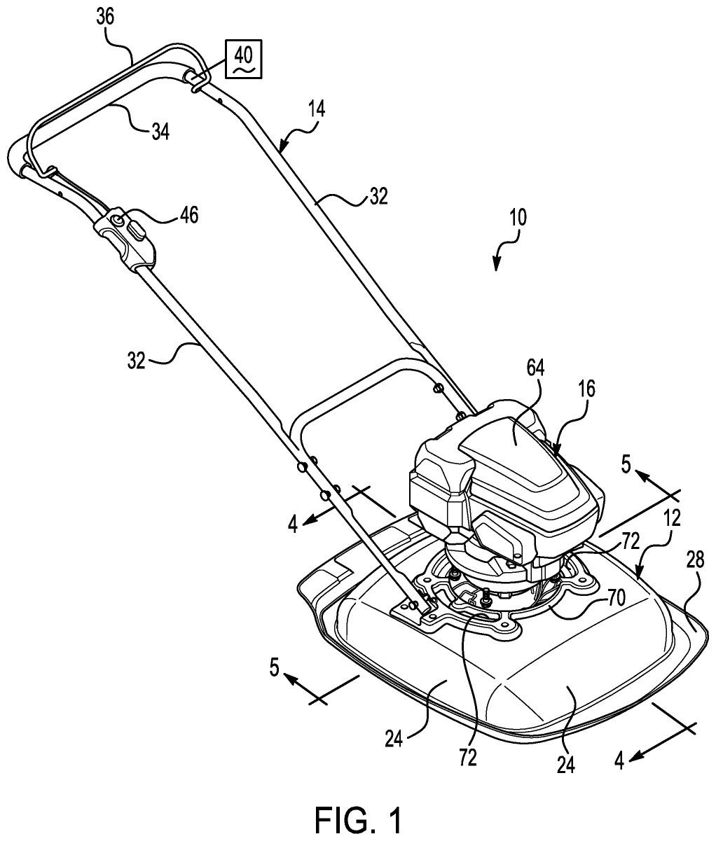

The electric power hover lawn mower 10 can have various designs, constructions, and components in different embodiments depending upon—among other possible factors—the size of the electric power hover lawn mower. In the embodiment of FIGS. 1-5, for example, the electric power hover lawn mower 10 has, as some of its primary components, a deck housing 12, a handle 14, a main housing 16, an electric motor 18, an impeller 20, and a blade 22; still, the electric power hover lawn mower could have more, less, and/or different components in other embodiments. The deck housing 12, also called a hood, houses certain components of the electric power hover lawn mower 10 and supports others, and serves as a main body of the electric power hover lawn mower 10. It can be composed of a high-density polyethylene (HPDE) material, in an example. The deck housing 12 has a shrouded skirt 24 on all of its sides, and defines a central opening 26. The electric motor 18 spans through the central opening 26. An upturned flange 28 extends from the shrouded skirt 24 and surrounds the shrouded skirt 24. The deck housing 12 defines an underside 30 where the deck housing 12 houses the impeller 20 and houses the blade 22. The underside 30 has an open bottom. At an exterior the deck housing 12 supports the handle 14, the main housing 16, and the electric motor 18.

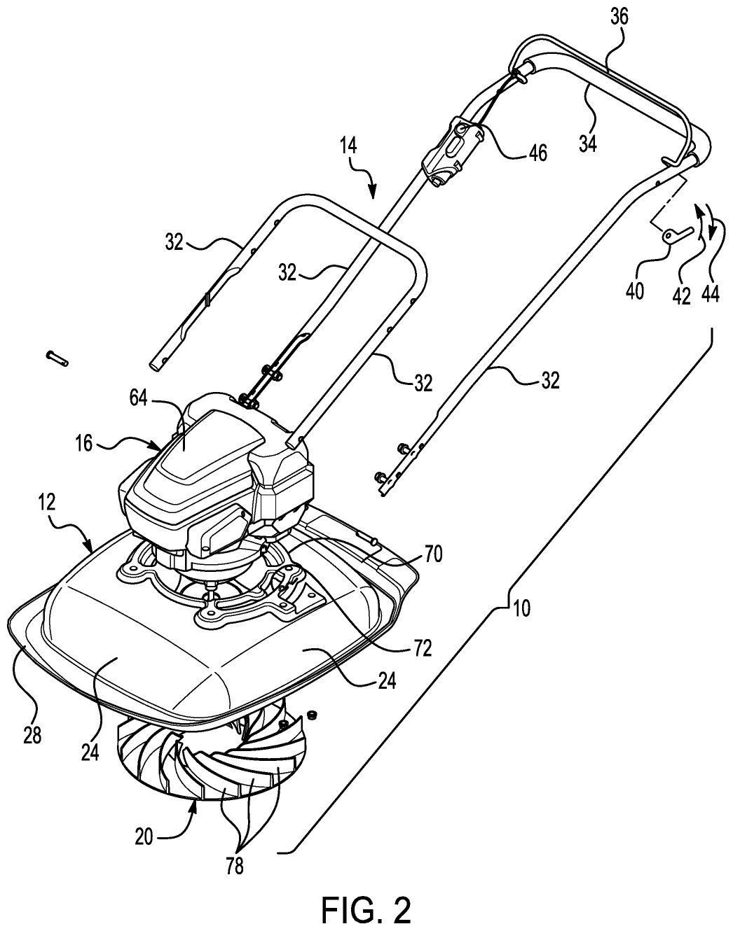

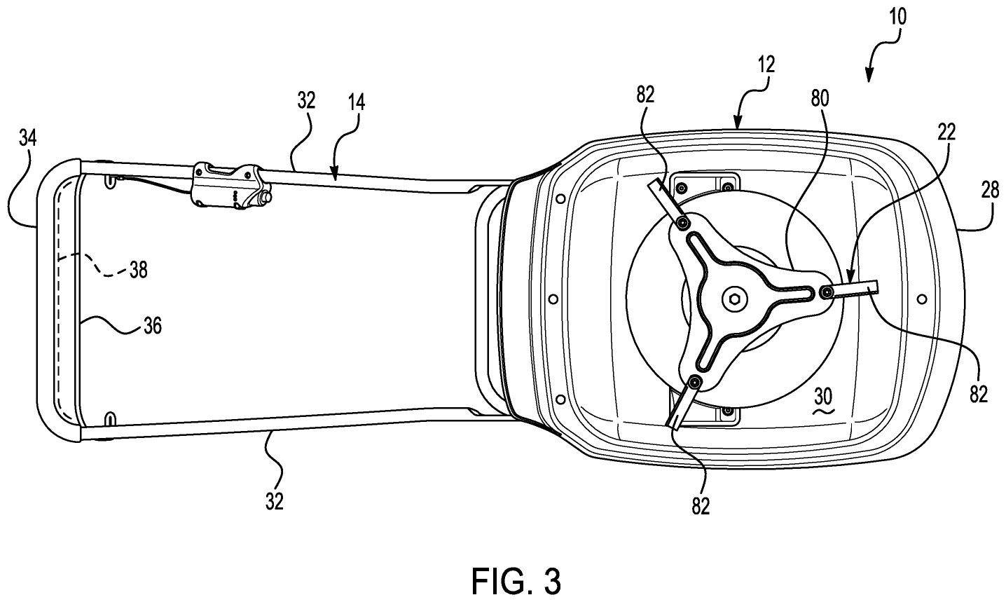

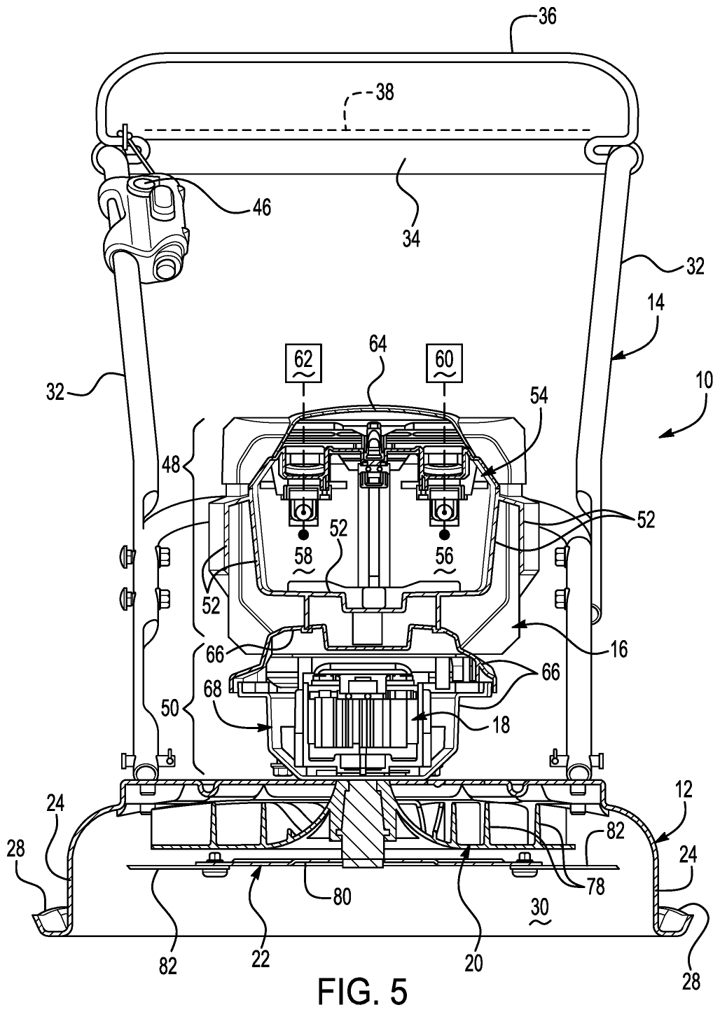

The handle 14 extends from the deck housing 12 and can be grasped by the operator amid use of the electric power hover lawn mower 10. The handle 14 has a pair of side arms 32 mounted at their proximal ends to the deck housing 12. A handlebar 34 extends between the side arms 32. To initiate activation of the electric motor 18 and deactivate the electric motor 18, a bail control bar 36 is provided at the handle 14. The bail control bar 36 is pivotably connected to the side arms 32 and can be moved by the operator from a released position, as presented in FIGS. 1 and 2, to a pulled position. The bail control bar 36 is spring-biased to the released position. The pulled position brings the bail control bar 36 in abutment or near abutment with the handlebar 34, and is represented in FIGS. 3 and 5 by a broken-line depiction 38. The bail control bar 36 can be in electrical communication with an electronic control unit (described below) of the electric power hover lawn mower 10 via wiring and circuitry such that, at the released position, the electric motor 18 is deactivated and remains deactivated (i.e., turned OFF) and, at the pulled position, the electric motor 18 is activated and remains activated (i.e., turned ON). Movement to the pulled position can work to pull a cable spanning to the electronic control unit, for instance.

As part of a two-step safety starting procedure, a lever 40 is provided at the bail control bar 36. The lever 40 is depicted in FIGS. 1 and 2. The lever 40 can take different forms in different examples, and serves to preclude the bail control bar 36 from moving to its pulled position and hence activating the electric motor 18 when the lever 40 is in a closed position. In an example form of FIG. 2, the lever 40 is hinged on one of the side arms 32 via bolting and is located near or at the pivotal connection of the bail control bar 36. The lever 40 can be a metal piece. At the closed position, the lever 40 physically obstructs and blocks the bail control bar 36 from movement; and at the open position, the lever 40 is clear of the bail control bar 36 and the bail control bar 36 is thus free to move to the pulled position. The lever 40 is swung outboard 42 by the operator when moved to the open position, and conversely is swung inboard 44 by the operator when moved to the closed position. Still, the lever 40 can take other forms in other embodiments to effect this preclusion and freeing functionality. The two-step safety starting procedure involves a first step of moving the lever 40 to the open position, and then a second step of moving the bail control bar 36 to the pulled position. The electric motor 18 is activated when these steps and actions are carried out in succession; that is, the operator cannot move the bail control bar 36 to the pulled position unless and until the operator moves the lever 40 to the open position. Inadvertent starting and electric motor activation is consequently avoided. In another embodiment of the two-step safety starting procedure and as presented in the figures, a switch 46 is provided at the handle 16. The switch 46 electrically communicates with the electronic control unit via wiring and circuitry. In the first step, the operator actuates the switch 46 by pressing it. Pressing the switch 46 readies the electric motor 18 for activation. And in the second step, the operator moves the bail control bar 36 to the pulled position. The electric motor 18 is thereby activated. In this other embodiment, the lever 40 need not be provided.

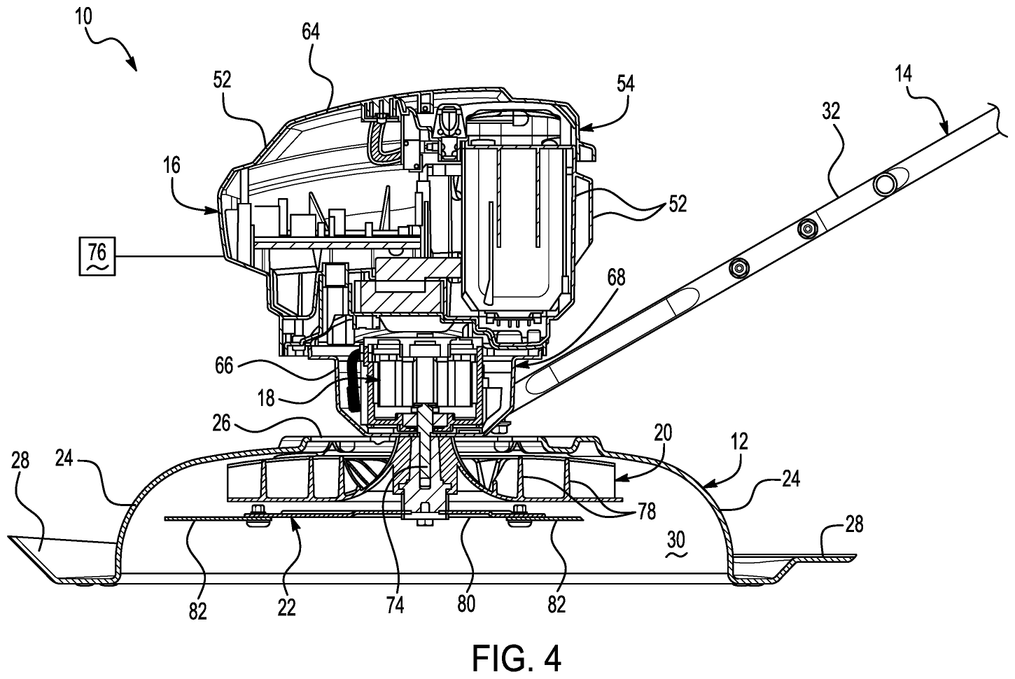

The main housing 16 serves as a battery holder for the electric power hover lawn mower 10, and houses the electric motor 18. The main housing 16 can have various designs and constructions in various embodiments. It can be composed of a plastic material. In the embodiment of the figures, and with particular reference to FIGS. 4 and 5, the main housing 16 is seated on top of the deck housing 12. The main housing 16 is segmented into an upper section 48 and a lower section 50. The upper section 48 houses batteries (described below) of the electric power hover lawn mower 10, and the lower section 50, on the other hand, houses the electric motor 18. The upper section 48 is situated vertically above the lower section 50, and the lower section 50 spans more immediately from the deck housing 12. The arrangement locates the batteries vertically above the electric motor 18. Together, the upper and lower sections 48, 50 constitute a vertically-stacked configuration of the batteries relative to the electric motor 18. The vertically-stacked configuration has been found to facilitate packaging among the components of battery reception and the electric motor 18, and facilitates the establishment of electrical communication thereamong.

The main housing 16 is made up structurally of various walls. A set of first walls 52 at the upper section 48 establishes a first interior region 54. The set of first walls 52 can include internal walls of the main housing 16, and can include external walls of the main housing 16. The first interior region 54 exhibits a distal location with respect to the deck housing 12. A first battery cavity 56 and a second battery cavity 58 reside within the first interior region 54; still, in other embodiments a single battery cavity could be provided. The first and second battery cavities 56, 58 receive respective insertion of a first battery 60 and a second battery 62; in an embodiment with a single battery cavity, a single battery could be provided. The first and second battery cavities 56, 58 are wholly enclosed by the main housing 16 at the upper section 48. A top cover 64 can be hinged for open and close motions in order to access the first and second cavities 56, 58, and for inserting and removing the first and second batteries 60, 62. When closed, as depicted in the figures, the first and second battery cavities 56, 58 and first and second batteries 60, 62 are protected against the external environment. The first and second battery cavities 56, 58 have battery receptors to suitably accept power discharge from the first and second batteries 60, 62. Electrical communication can be provided between the first and second battery cavities 56, 58 and batteries 60, 62 and the electric motor 18.

The first and second batteries 60, 62 provide power to the electric motor 18, and can be of various types and can have various specifications in different embodiments. In an example, the first and second batteries 60, 62 are lithium-ion batteries. Here, specifications for a battery pack can include: a rated voltage of 125V d.c., a rated capacity of 2500 mAh, a maximum discharge current of 20 A, and a charging voltage/current of 126V d.c./4A. Still, other specifications for the battery pack may be suitable. In this example, specifications for a battery cell can include: a rated capacity of 2500 mAh, a charging voltage of up to 4.2V d.c., and a discharging voltage of up to 2.7V d.c. Still, other specifications for the battery cell may be suitable.

A set of second walls 66 at the lower section 50 establishes a second interior region 68. The set of second walls 66 can include internal walls of the main housing 16, and can include external walls of the main housing 16. The second interior region 68 exhibits a proximal location with respect to the deck housing 12. The set of second walls 66 can be separate and distinct structures from the set of first walls 52, can be unitary and monolithic extensions of the set of first walls 52, or can be a combination of both. The first and second interior regions 54, 68 are distinct regions relative to each other, with an intervening wall or walls spanning between them. The electric motor 18 is situated within the second interior region 68.

The electric motor 18 incites rotational drive of the impeller 20 and of the blade 22 amid use of the electric power hover lawn mower 10. The electric motor 18 is powered by the first and second batteries 60, 62. In this embodiment, the electric motor 18 is seated on top of the deck housing 12 and can be situated on a mount formation 70, as illustrated in FIGS. 1 and 2. The mount formation 70 facilitates seating of the electric motor 18 and provides inlet recesses 72 for letting air enter the underside 30 upon being drawn-in by the spinning impeller 20. Components of the electric motor 18 such as its rotor, stator, windings, and commutator are housed at the second interior region 68. With particular reference to FIG. 4, a shaft 74 of the electric motor 18 extends from the main housing 16 for connection with the impeller 20 and with the blade 22. The shaft 74 spans through the central opening 26. The shaft 74 spins and rotates when the electric motor 18 is activated and outputs rotational drive to the impeller 20 and to the blade 22. Due to the arrangement of the electric motor 18 on the deck housing 12, the shaft 74 exhibits a vertical arrangement with respect to the underlying ground. In an example, specifications of the electric motor 18 can include: a voltage of 125V DC, a rated output of 1250 W, a rated speed of 2900 RPM, a rated current of 13 A, and a rated torque of 4.15N.M. Still, other specifications for the electric motor 18 may be suitable.

An electronic control unit 76 is programmed to manage operation of the electric power hover lawn mower 10, including activation and deactivation of the electric motor 18, among other possible operational functionalities. The electronic control unit 76 is depicted in FIG. 4. In this embodiment, the electronic control unit 76 is housed by the main housing 16 at the first interior region 54, but could be located elsewhere such as at the second interior region 68 in other embodiments. The electronic control unit 76 can have electrical communication via wiring and circuitry with the electric motor 18, with the first and second battery cavities 56, 58, and with the bail control bar 36. By way of the electrical communications, the electrical control unit 76 receives operational commands and instructions from the bail control bar 36, and in turn sends operational commands and instructions to the electric motor 18.

The impeller 20 spins rapidly amid use and produces increased pressure beneath the deck housing 12 and thereby elevates the electric power hover lawn mower 10 slightly above the underlying ground. This causes floatation of the electric power hover lawn mower 10. The impeller 20 can be composed of a plastic material. Referring now to FIGS. 2, 4, and 5, the impeller 20 resides at the underside 30 of the deck housing 12 in assembly. The impeller 20 is situated vertically above the blade 22. The impeller 20 is fixed to the shaft 74 of the electric motor 18, whereby rotation of the shaft 74 causes concurrent rotation of the impeller 20. When spun about its central axis, a series of curved fan blades 78 work to draw-in air outside of the deck housing 12 to the underside 30, and increase the pressure of air present at the underside 30.

The blade 22 spins rapidly and comes into contact with grass and cuts grass amid use of the electric power hover lawn mower 10. The blade 22 can take different forms in different embodiments. In the embodiment of the figures, and with reference now to FIG. 3, the blade 22 is an assembly of components that includes a disk 80 and multiple blade knives 82 attached to the disk 80 and extending therefrom. Like the impeller 20, the blade 22 resides at the underside 30 of the deck housing 12 and is fixed to the shaft 74 of the electric motor 18. Rotation of the shaft 74 upon activation of the electric motor 18 causes rotation of the blade 22. In other forms, the blade 22 could be a single elongated blade knife, a set of string blades, or something else.

It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular embodiments and are not to be construed as limitations on the scope of the disclosure or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. An electric power hover lawn mower, comprising:
a deck housing having an underside;
a handle extending from said deck housing;
a main housing supported on said deck housing and having at least one battery cavity for reception of at least one battery;
an electric motor powerable by the at least one battery, said electric motor housed by said main housing and having a shaft;
an impeller driven to rotate by said shaft of said electric motor upon activation of said electric motor, said impeller residing at said underside of said deck housing; and
a blade driven to rotate by said shaft of said electric motor upon activation of said electric motor, said blade residing at said underside of said deck housing.

2. The electric power hover lawn mower as set forth in claim 1, further comprising a bail control arm located at said handle and a lever located adjacent said bail control arm, wherein, in order to activate said electric motor, said lever is moved to an open position freeing movement of said bail control arm, and said bail control arm is moved to a pulled position.

3. The electric power hover lawn mower as set forth in claim 2, wherein the movement of said lever to said open position and said bail control arm to said pulled position are performed in succession in order to activate said electric motor and rotate said impeller and rotate said blade.

4. The electric power hover lawn mower as set forth in claim 2, wherein said bail control arm electrically communicates with an electronic control unit of the electric power hover lawn mower, the electronic control unit being in electrical communication with said electric motor.

5. The electric power hover lawn mower as set forth in claim 1, further comprising an electronic control unit in electrical communication with the at least one battery and in electrical communication with said electric motor.

6. The electric power hover lawn mower as set forth in claim 1, wherein said at least one battery cavity resides at an interior of said main housing and is located vertically above said electric motor.

7. The electric power hover lawn mower as set forth in claim 1, wherein said main housing has an upper section and a lower section, said lower section spanning from said deck housing and said upper section spanning from said lower section, said at least one battery cavity residing at said upper section and said electric motor residing at said lower section.

8. The electric power hover lawn mower as set forth in claim 1, wherein said main housing has a plurality of first walls establishing a first interior region, and has a plurality of second walls establishing a second interior region, said at least one battery cavity residing at said first interior region, and said electric motor residing at said second interior region.

9. The electric power hover lawn mower as set forth in claim 1, further comprising at least one battery received in said at least one battery cavity, said at least one battery providing power to said electric motor upon activation of said electric motor.

10. The electric power hover lawn mower as set forth in claim 1, wherein said at least one battery cavity is a first battery cavity and a second battery cavity, and further comprising a first battery received in said first battery cavity and a second battery received in said second battery cavity.

11. The electric power hover lawn mower as set forth in claim 11, wherein said first battery is a first lithium-ion battery and said second battery is a second lithium-ion battery.

12. An electric power hover lawn mower, comprising:
a deck housing;
a handle extending from said deck housing;
a main housing supported on said deck housing, said main housing having a plurality of first walls establishing a first interior region, having a plurality of second walls establishing a second interior region, and having at least one battery cavity residing at said first interior region;
an electric motor residing at said second interior region and having a shaft;
an impeller driven to rotate by said shaft of said electric motor upon activation of said electric motor; and
a blade driven to rotate by said shaft of said electric motor upon activation of said electric motor.

13. The electric power hover lawn mower as set forth in claim 13, wherein said first interior region is distinct with respect to said second interior region.

14. The electric power hover lawn mower as set forth in claim 13, wherein said first interior region is located vertically above said second interior region.

15. The electric power hover lawn mower as set forth in claim 13, wherein said first interior region is located distal relative to said deck housing, and said second interior region is located proximal relative to said deck housing.

16. The electric power hover lawn mower as set forth in claim 13, further comprising an electronic control unit residing at said first interior region and being in electrical communication with said electric motor.

17. The electric power hover lawn mower as set forth in claim 13, further comprising a bail control arm located at said handle and a lever located adjacent said bail control arm, wherein, in order to activate said electric motor, said lever is moved to an open position freeing movement of said bail control arm, and said bail control arm is moved to a pulled position.

18. An electric power hover lawn mower, comprising:
a deck housing having an underside;
a handle extending from said deck housing;
a bail control arm located at said handle and a lever located adjacent said bail control arm;
a main housing supported on said deck housing and having at least one battery cavity;
at least one battery received in said at least one battery cavity;
an electronic control unit housed by said main housing;
an electric motor powerable by said at least one battery, said electric motor housed by said main housing and having a shaft;
an impeller driven to rotate by said shaft of said electric motor upon activation of said electric motor, said impeller residing at said underside of said deck housing; and
a blade driven to rotate by said shaft of said electric motor upon activation of said electric motor, said blade residing at said underside of said deck housing;
wherein, in order to activate said electric motor and rotate said impeller and rotate said blade, said lever is moved to an open position and said bail control arm is moved to a pulled position.

19. The electric power hover lawn mower as set forth in claim 18, wherein said main housing has an upper section and a lower section, said lower section spanning from said deck housing and said upper section spanning from said lower section, said at least one battery and said at least one battery cavity residing at said upper section and said electric motor residing at said lower section.
